(19) United States
(12) Patent Application Publication
(10) Pub. No.: US 2023/0129534 A1
(43) Pub. Date: Apr. 27, 2023

(54) DEVICE, SYSTEM, AND METHOD FOR ENHANCED PROCESSING OF SENSOR-BASED ANNOTATIONS

(71) Applicant: MOTOROLA SOLUTIONS, INC., Chicago, IL (US)

(72) Inventors: Francesca SCHULER, Chicago, IL (US); Trent J. MILLER, Chicago, IL (US)

(21) Appl. No.: 17/509,963

(22) Filed: Oct. 25, 2021

(51) Int. Cl. G06Q 50/26

(52) U.S. Cl. CPC G06Q 50/265

(57) ABSTRACT

A device, system, and method for enhanced processing of sensor-based annotations is provided. A device determines respective confidence scores for a plurality of annotations associated with a given incident, the plurality of annotations provided at a timeline for the given incident, the timeline rendered at a display screen. The device determines that two or more annotations, of the plurality of annotations, are related. The device determines, from the respective confidence scores, a combined confidence score for the two or more annotations that are related. The device renders, at the display screen showing the timeline, at the two or more annotations that are related, the combined confidence score.

### BACKGROUND OF THE INVENTION

Public safety incidents are generally tracked using electronic sensor data, such as audio data, video data, and the like, which may be processed by computer-based public safety engines to ensure incident records are accurate.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a system for enhanced processing of sensor-based annotations, in accordance with some examples.

FIG. 1B depicts an example of timeline being implemented in the system of FIG. 1A without combined confidence scores, in accordance with some examples.

FIG. 1B depicts an example of timeline being implemented in the system of FIG. 1A with combined confidence scores, in accordance with some examples.

FIG. 2 is a device diagram showing a device structure of communication device for enhanced processing of sensor-based annotations, in accordance with some examples.

FIG. 3 is a flowchart of a method for enhanced processing of sensor-based annotations, in accordance with some examples.

FIG. 4 depicts another example of timeline being implemented in the system of FIG. 1A with an interface to select respective related annotations with respective combined confidence scores that meet given threshold conditions, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Public safety incidents are generally tracked using electronic sensor data, such as audio data, video data, and the like, which may be processed by computer-based public safety engines, and the like, to generate annotations thereof, and to assess for accuracy, to ensure incident records are accurate. As some of the sensor data may not be accurate, inaccuracies in the incident records may occur. Thus, there exists a need for an improved technical method, device, and system for enhanced processing of sensor-based annotations.

Hence, provided herein is a device, system, and method for enhanced processing of sensor-based annotations. For example, a computing device of a Public-Safety Answering Point (PSAP) and/or Digital Evidence Management Service (DEMS) may be receiving sensor data from sensor devices and generating annotations therefrom, though some annotations may originate at devices operated by public-safety officers, PSAP call-takers and the like. In general, the computing device may be implementing a timeline engine, which renders a plurality of annotations of a given incident at a display screen, for example in a time-based manner at a timeline. The sensor devices, may comprise any suitable device that acquires sensor data, the sensor data providing indications of events and/or information associated with the given incident, and may include, but are not limited to devices that include a microphone and/or a camera, which acquires audio data and/or video data and/or image data, and/or any other suitable type of sensor data. The plurality of annotations rendered at the timeline may hence comprise indications of the events and/or information associated with the given incident.

The computing device generally determines respective confidence scores for the plurality of annotations, which may be generated via a confidence engine. The computing device may determine that two or more annotations, of the plurality of annotations, are related (e.g., each of the annotations are related to a same and/or similar event, and/or same and/or similar information) and determine a combined confidence score for the two or more annotations that are related. Such a combined confidence score may represent a better, overall, confidence score for the two or more annotations than individual confidence scores. The computing device may, via the timeline engine, render, at the display screen showing the timeline, at the two or more annotations that are related, the combined confidence score. Hence, overall, more efficient processing of sensor-based annotations occur, for example to better determine accuracy thereof, which may generally lead to better deployment of public-safety resources in investigating the given incident.

An aspect of the specification provides a method comprising: determining, via a computing device, respective confidence scores for a plurality of annotations associated with a given incident, the plurality of annotations provided at a timeline for the given incident, the timeline rendered at a display screen; determining, via the computing device, that two or more annotations, of the plurality of annotations, are related; determining, via the computing device, from the respective confidence scores, a combined confidence score for the two or more annotations that are related; and rendering, via the computing device, at the display screen showing the timeline, at the two or more annotations that are related, the combined confidence score.

Another aspect of the specification provides a device comprising: a controller configured to: determine respective confidence scores for a plurality of annotations associated with a given incident, the plurality of annotations provided at a timeline for the given incident, the timeline rendered at a display screen; determine that two or more annotations, of the plurality of annotations, are related; determine, from the respective confidence scores, a combined confidence score for the two or more annotations that are related; and render, at the display screen showing the timeline, at the two or more annotations that are related, the combined confidence score.

Each of the above-mentioned aspects will be discussed in more detail below, starting with example system and device architectures of the system, in which the embodiments may be practiced, followed by an illustration of processing blocks for achieving an improved technical method, device, and system for enhanced processing of sensor-based annotations.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

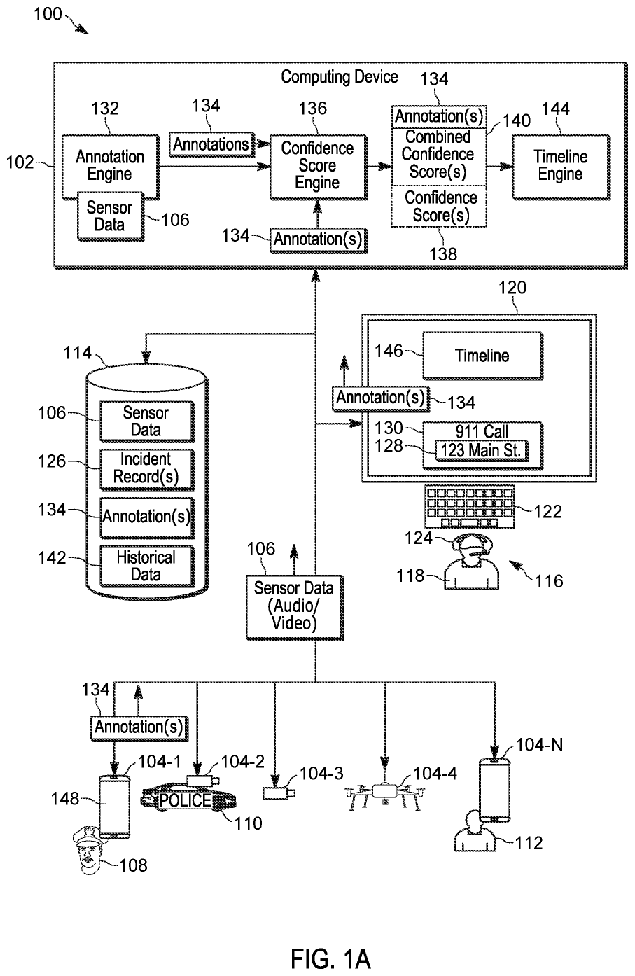

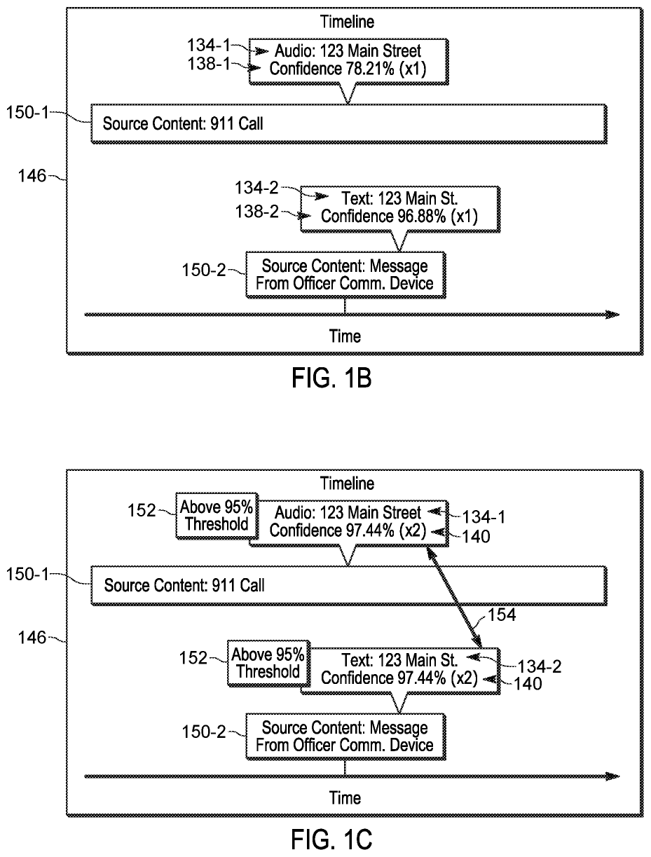

Attention is directed to FIG. 1A, which depicts an example system 100 for enhanced processing of sensor-based annotations. The various components of the system 100 are in communication via any suitable combination of wired and/or wireless communication links, and communication links between components of the system 100 are depicted in FIG. 1A, and throughout the present specification, as double-ended arrows between respective components; the communication links may include any suitable combination of wireless and/or wired links, and/or wireless and/or wired communication networks, and the like.

Herein, reference will be made to engines, which may be understood to refer to hardware (e.g., a controller, such as a processor, a central processing unit (CPU), an integrated circuit or other circuitry, such as a hardware element with no software elements such as an application specific integrated circuit (ASIC), a Field Programmable Gate Array (FPGA), etc.) or a combination of hardware and software (e.g., a combination of hardware and software includes software hosted at hardware such that the software, when executed by the hardware, transforms the hardware into a special purpose hardware, such as a software module that is stored at a processor-readable memory implemented or interpreted by a processor), or hardware and software hosted at hardware (e.g., programming such as machine- or processor-executable instructions, commands, or code such as firmware, a device driver, programming, object code, etc. as stored on hardware) and/or implemented as a system-on-chip architecture and the like.

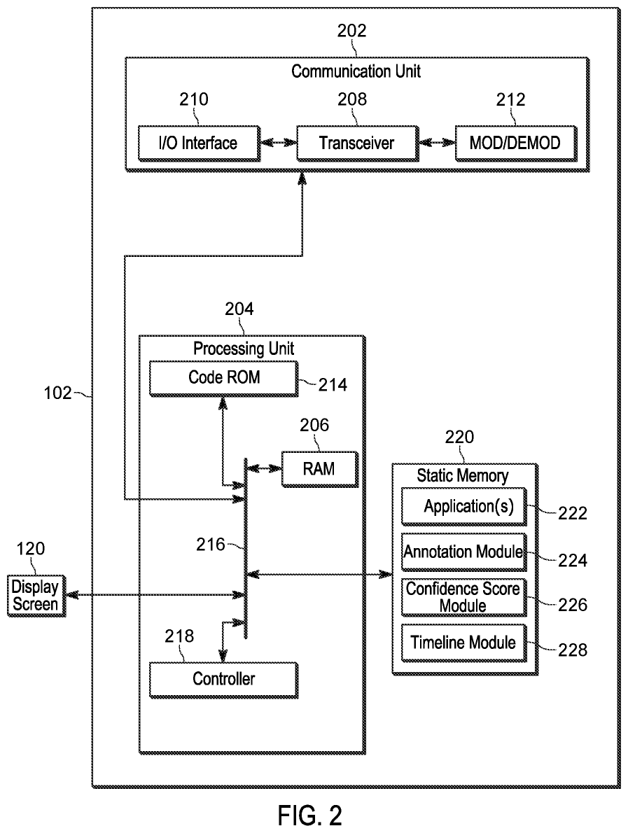

The system 100 comprises a computing device 102, such a PSAP computing device and/or a DEMS computing device, which may comprise one or more servers and/or one or more cloud computing devices, and the like, in any suitable format and/or combination. In some examples, functionality of the computing device 102 may be distributed over a plurality of servers, a plurality of cloud computing devices and the like. Details of the computing device 102 are described in more detail below with respect to FIG. 2.

The system 100 further comprises one or more sensor devices 104-1, 104-2, 104-3, 104-4 . . . 104-N, which may be acquiring sensor data 106 (and/or annotations associated with a given incident and/or a plurality of given incidents. Hereafter the one or more sensor devices 104-1, 104-2, 104-3, 104-4 . . . 104-N will be interchangeably referred to, collectively, as the sensor devices 104 and, generically (e.g., in the singular) as a sensor device 104. This convention will be used throughout the present specification.

The sensor devices 104 may comprise any suitable device that includes one or more sensors that may acquire sensor data associated with a given incident, including, but not limited to, audio data, video data, image data, and the like. Hence, sensors of the sensor devices 104 may include audio sensors (e.g., such as microphones), video and/or image sensors (e.g., such as cameras and/or video cameras), and the like, but may further include license plate detectors, gas sensors, chemical sensors, and the like, which generate corresponding sensor data 106.

As depicted, the sensor devices 104 include: the sensor device 104-1 in the form of a communication device operated by a first responder 108, and which may include a microphone and/or camera; the sensor device 104-2 in the form of a dashboard video camera (e.g., a dashcam) of a public safety vehicle 110; the sensor device 104-3 in the form of a video camera, which may comprise a video camera operated by a public safety agency (e.g., such as a police agency) and/or a video camera operated by private entity, such as a security camera for a business and/or building and/or home, and the like; the sensor device 104-4 in the form of a drone, which may include a microphone and/or a camera; and the sensor device 104-N in the form of a communication device operated by a user 112 who may be a member of the general public calling the PSAP in a 911 call, and the like, and the sensor device 104-N may include a microphone and/or camera. In a particular example, sensor data 106 from the sensor device 104-N may comprise audio data of the 911 call. However other types of sensor devices 104 may include, but are not limited to, a body worn camera (e.g., of a first responder), gas sensors and/or chemical sensors (e.g., of a first responder), a license plate detector, and the like.

A number “N” of the sensor devices 104 is depicted, and the number “N” may be any suitable number, which may be as few as one sensor device 104, tens of sensor devices 104, hundreds of sensor devices 104, and the like. Furthermore, some sensor devices 104 may be at least partially manually operated (e.g., such as the communication devices of the sensor devices 104-1, 104-N) while other sensor devices may be fully automated.

Furthermore, while the first responder 108 is described herein with respect to police officers, the first responder 108 may comprise any suitable first responders that may be associated with an incident, including, but not limited to, fire fighters, emergency medical technicians, as private security guards, and the like. Similarly, incidents described herein may include, but are not limited to, public safety incidents and/or other types of incidents.

In general, as depicted, the sensor data 106 is being transmitted to the computing device 102 for processing, as described in more detail below. In some examples the sensor data 106 may be streamed to the computing device 102. For example, video and/or audio from a camera and/or microphone may be streamed to the

In other examples, a sensor device 104 may include an event and/or information analysis engine, and the like, which is generally configured to detect given events and/or types of information in the sensor data 106, such as a gunshot (e.g., in audio data and/or video data), a license plate, an address, and the like; in some of these examples, the sensor data 106 may be transmitted when a given event and/or given information are detected in the sensor data 106 by the event and/or information analysis engine. In particular, the event and/or information analysis engine may comprise machine learning algorithms and/or convolutional neural networks (CNNs), and the like, configured to detect given events and/or types of information in the sensor data 106.

Furthermore, as depicted, the system 100 further comprises a storage component 114, which, as depicted, is provided in the form of a database, however the storage component 114 may be in any suitable format and/or may be provided as one or more memories, one or more databases, one or more cloud computing devices, and the like, and/or a combination thereof. As depicted the storage component 114 may store the sensor data 106 and/or a portion of the sensor data 106. While not depicted, the sensor data 106 and/or a portion of the sensor data 106 may alternatively be copied to an evidence repository for a DEMS and/or the storage component 114 may further comprises such an evidence repository for a DEMS.

As depicted, the computing device 102 is further in communication with a PSAP terminal 116, operated, for example, by a user 118, such as a PSAP call-taker, a dispatcher, and the like.

While only one PSAP terminal 116 is depicted with the computing device 102, the computing device 102 may be in communication with tens to hundreds of terminals 116, and/or any suitable number of PSAP terminals 116, which may be local to, and/or remote from, an associated PSAP and/or the computing device 102.

As depicted, the PSAP terminal 116 includes a display screen 120, one or more input devices 122 (e.g., such as keyboards (as depicted), pointing devices and the like), and a combination a speaker and a microphone, for example in the form of a headset 124 worn by the user 118. In general, the PSAP terminal 116 may include any suitable combination of components that enable a user 118 to communicate on a call (e.g., 911 calls to a PSAP) and/or dispatch first responders (e.g., such as the first responder to 108) incidents, and/or interact with the display screen 120 and/or communicate with the computing device 102, and the like.

For example, as depicted, the user 118 may be communicating on a 911 call for example via the headset 124, with the user 112 of the communication device of the sensor device 104-N (e.g., as represented by sensor data 106 from the sensor device 104-N). For example, the user 118 may be providing information pertaining to a given incident, which may be associated with an incident record 126 stored at the storage component 114, and/or which may be generated by the user 118 operating the input device 122, and stored in the storage component 114. As depicted, the user 118 may be operating the input device 122 to enter annotations associated with the given incident into a field 128 and/or fields of a graphic user interface (GUI) 130; for example, as depicted, an address of “123 Main St.” is entered at the field 128.

However, as depicted, the computing device 102 may be operating an annotation engine 132 configured to receive the sensor data 106 and generate annotations therefrom. For example, the annotation engine 132 is generally configured to detect given events and/or types of information in the sensor data 106, such as a gunshot (e.g., in audio data and/or video data), a license plate, an address, and the like. In particular, the annotation engine 132 may comprise machine learning algorithms and/or CNNs, and the like, configured to detect given events and/or types of information in the sensor data 106. In a particular example, the annotation engine 132 may be receiving audio data of the 911 call from the sensor device 104-N and analyzing the audio data to extract an address, such as the address “123 Main St.”. Hence, the annotation engine 132 may comprise a speech-to-text engine configured to convert text from speech, and the like.

However, the annotation engine 132 may comprise other types of engines, including, but not limited to, audio analysis engines, video analysis engines, and the like, configured to detect given types of sounds and/or images in audio and/or video, such as gunshots, license plates, given suspect images, and the like.

Annotations may alternatively originate from other communication devices, such as the communication device of the sensor device 104-1 operated by the first responder 108. For example, the communication device of the sensor device 104-1 may be implementing an incident application, which may accept annotations associated with a given incident, for example by way of the first responder 108 operating the communication device of the sensor device 104-1. Indeed, it is hence understood that sensor devices 104 may generate annotations.

Hence, as depicted, annotations 134 may be generated by the annotation engine 132 from the sensor data 106 and/or annotations 134 may originate from a sensor device 104, and/or annotations 134 may originate from the PSAP terminal 116.

It is furthermore understood that one or more annotations 134 may include an incident identifier associating the one or more annotations 134 with an incident record 126 for a given incident, and/or the computing device 102 may be generally configured to associate annotations 134 with a given incident. For example, an annotation 134 may be time stamped and further comprise an indication of events and/or information, which the computing device 102 may determine is associated with a given incident associated with an incident record 126. For example, an annotation 134 may comprise an address that is stored at an incident record 126 for a given incident, and a time stamp of the annotation 134 may comprise a time associated with the given incident as stored at the incident record 126; the computing device 102 may compare such information of an annotation 134 and an incident record 126 and associate the annotation 134 and a given event of the incident record 126.

Furthermore, as depicted, one or more annotations 134 may be stored at the storage component 114. For example, previously generated annotations 134 may be stored at the storage component 114 prior to being associated with a given incident and, once an incident record 126 is generated for a given incident, the computing device 102 may compare stored annotations 134 with the incident record 126 to determine associations therebetween.

As depicted, the computing device 102 is implementing a confidence score engine 136, which is generally configured to determine respective confidence scores 138 for a plurality of annotations 134 associated with a given incident. The confidence score engine 136 may be implemented using programmatic algorithms configured to determine confidence scores. Alternatively, the confidence score engine 136 may be implemented using one or more machine learning algorithms and/or CNNs configured to determine confidence scores.

For example, a confidence score 138 may generally represent an indication of reliability and/or confidence that an annotation 134 is accurate and may comprise a confidence score 138 between 0 and 100, with 0 being a lowest confidence score 138 (e.g., indicating lowest or no accuracy of an annotation 134) and 100 being a highest confidence score 138 (e.g., indicating highest accuracy of an annotation 134). The confidence score engine 136 may assign a confidence score 138 in any suitable manner; for example, a confidence score 138 may be based on a determined quality of sensor data 106, from which an annotation 134 was generated, a type of sensor device 104 that generated the sensor data 106, an accuracy of a sensor device 104 and the like.

In a particular example using speech to text, audio data of given sensor data 106, from which an address was determined, may be processed to determine background noise levels of the audio data, word error rates, and the like. When background noise levels and/or word error rates are “high” (e.g., above one or more threshold noise levels and/or threshold word error rates), a confidence score 138 for an annotation 134 comprising an address extracted from the audio data may be decreased. Conversely, when background noise levels and/or word error rates are “low” (e.g., below one or more threshold noise levels and/or threshold word error rates), a confidence score 138 for an annotation 134 comprising an address extracted from the audio data may be increased.

Confidence scores 138 may alternatively be based on a type and/or accuracy of a sensor device 104 used to capture the sensor data 106. For example, some sensor devices 104 may be more accurate at capturing audio and/or video than other sensor devices 104 due to types of microphones and/or types of video cameras of the respective sensor devices 104. For example, a video camera having a relatively higher resolution may be more accurate than a video camera having a relatively lower resolution. Hence, when an annotation 134 is generated from sensor data 106 that originated from a video camera, of a sensor device 104, having a relatively higher resolution sensor, a confidence score 138 for the annotation 134 may be increased. Conversely, when an annotation 134 is generated from sensor data 106 that originated from a video camera, of a sensor device 104, having a relatively lower resolution sensor, a confidence score 138 for the annotation 134 may be decreased.

Furthermore, the computing device 102 and/or the confidence score engine 136 may be configured to determine that two or more annotations 134, of the plurality of annotations 134, are related. For example, two or more annotations 134 associated with a given event may indicate the same address and/or a same license plate number. The confidence score engine 136 may determine, from the respective confidence scores 138 of the two or more annotations 134, a combined confidence score 140 for the two or more annotations 134 that are related.

Such a combined confidence score 140 may comprise an average of the confidence scores 138 for the two or more annotations 134 that are related, and/or the combined confidence score 140 may be based on a given weighting scheme that combines the respective confidence scores 138 for the two or more annotations 134 that are related. An example weighting scheme is described in more detail below.

Furthermore, a combined confidence score 140 also be between 0 and 100 similar to a confidence score 138.

However, a combined confidence score 140 may be higher than respective confidence scores 138, from which the combined confidence score 140 was determined. For example, when respective confidence scores 138 for two annotations 134 that are generally similar and/or the same (e.g., both annotations 134 represent a same address, but in different formats), a combined confidence score 140 may be higher than the two respective confidence scores 138. Put another way, when two related annotations 134 are identical and/or almost identical, a combined confidence score 140 for the related annotations 134 may be increases relative to their respective confidence scores 138.

In some examples, the combined confidence score 140 may be based on historical data 142 associated with the sensor devices 104 and/or the first responder 108 and/or the user 112 and/or the PSAP terminal 116 and/or the user 118. For example, the historical data 142 may comprise weights indicating accuracy of previous annotations 134 associated with the sensor devices 104 and/or the first responder 108 and/or the user 112 and/or the PSAP terminal 116 and/or the user 118. For example, when a previous annotation 134 associated with a given sensor device 104 was determined to be inaccurate (e.g., addresses that determined from sensor data 106 that originated from the given sensor device 104 were consistently determined to be at least partially inaccurate), a weight for a respective confidence score 138 of new annotations 134 associated with the given sensor device 104 may be lowered. Similarly, when a previous annotation 134 associated with a given sensor device 104 was determined to be accurate (e.g., addresses that determined from sensor data 106 that originated from the given sensor device 104 were consistently determined to be accurate), a weight for a respective confidence score 138 of new annotations 134 associated with the given sensor device 104 may be raised.

The historical data 142 may be machine-generated, for example using programmatic and/or machine-learning algorithms, and the like, that may compare accuracy of confidence scores 138 generated by the confidence score engine 136 at a later time, for example once a given incident associated with an incident record 126 is resolved. For example, an algorithm may compare a verified address of an incident record 126 with addresses of annotations 134 that were assigned confidence scores 138. Confidence scores 138 of annotations 134 that had an accurate address (e.g., that matched the verified address) may lead to a higher weight for an associated sensor device 104 in the historical data 142. Similarly, confidence scores 138 of annotations 134 that had an inaccurate address (e.g., that did not match and/or only partially matched the verified address) may lead to a lower weight for an associated sensor device 104 in the historical data 142.

Furthermore, when subsets of annotations 134 are determined to be respectively related, respective combined confidence scores 140 for the subsets of related annotations 134 may be determined.

In general, the confidence score engine 136 provides the annotations 134 and associated combined confidence scores 140 to a timeline engine 144. As depicted, some annotations 134 may not be associated with other annotations 134. Hence, as depicted, the confidence score engine 136 may provide, to the timeline engine 144 confidence scores 138 for such annotations 134 that are not associated with other annotations 134.

The timeline engine 144 generally generates a timeline 146 for a given incident with associated annotations 134 rendered on the timeline 146. In particular, the computing device 102 and/or the timeline engine 144, renders, at a display screen, such as the display screen 120, the timeline 146 showing two or more annotations 134 that are related, and a combined confidence score 140 for the two or more annotations 134 that are related. However, the timeline 146 may be rendered at any suitable display screen, such as a display screen 148 of the communication device of the sensor device 104-1 operated by the first responder 108, for example within an incident application.

Attention is next directed to FIG. 1B and FIG. 1C, which respectively depicts the timeline 146, as rendered at a display screen, before and after implementation of the combined confidence scores 140.

For example, FIG. 1B depicts the timeline 146, which comprises a time axis (e.g., labelled “Time”) representing increasing time from left to right, and indications of events 150-1, 150-2 associated with incidents (e.g., the indications of events 150 and/or an indication of an event 150). The indications of events 150 generally representing received sensor data 106 and/or annotation 134. For example, as depicted, the indication of the event 150-1 represents a 911 call to the PSAP terminal 116, with opposite ends of the indication of the event 150-1 indicating a start time and a stop time of the 911 call at the time axis. The indication of an event 150-2 represents an annotation 134 received from a first responder communication device (e.g., in the form of a textual message (e.g., an email, a short message service (SMS) text, and the like) from an “Officer Comm. Device”), such as the sensor device 104-1; a line from the indication of the event 150-2 to the time axis represent a time that the message was received.

The timeline of FIG. 1B further shows an annotation 134-1 associated with the indication of the event 150-1, the annotation 134-1 also provided at the timeline 146. As depicted, the annotation 134-1 comprises text extracted from audio data (e.g., sensor data 106) of the 911 call, the text comprising an address “123 Main Street”. The annotation 134-1 further comprises a source of the text, “Audio” indicating that the text was extracted from audio data. As depicted, the annotation 134-1 is provided with a respective confidence score 138-1 of “78.21%”; as depicted, the confidence score 138-1 is provided with an indication of a number of related annotations 134, in this example “x1” indicating that the respective confidence score 138-1 is associated with only one annotation 134-1.

Similarly, FIG. 1B further shows an annotation 134-2 associated with the indication of the event 150-2, the annotation 134-2 also provided at the timeline 146. As depicted, the annotation 134-2 comprises text extracted from a message, the text comprising an address “123 Main St.”. The annotation 134-2 further comprises a source of the text, “Text” indicating that the text was extracted from a textual message. As depicted, the annotation 134-2 is provided with a respective confidence score 138-2 of “96.88%”; as depicted, the confidence score 138-2 is provided with a number of related annotations 134, in this example “x1” indicating that the respective confidence score 138-2 is associated with only one annotation 134-2.

However, it is apparent that the annotations 134-1, 134-2 are associated with each other as each represent a same address, but in different formats (e.g., in the annotation 134-1, a word “street” is entirely provided, while in the annotation 134-2, a word “street” is represented by an abbreviation “St.”).

As such, rather than the timeline 146 as depicted in FIG. 1B, a timeline 146 as depicted in FIG. 1C may be provided, and/or the timeline 146 as depicted in FIG. 1B, may be modified to the timeline 146 as depicted in FIG. 1C.

The timeline 146 as depicted in FIG. 1C is substantially similar to the timeline 146 as depicted in FIG. 1B, however in FIG. 1C the respective confidence scores 138-1, 138-2 have been replaced with a combined confidence score 140 that is the same for both annotations 134-1, 134-2. For example, as the annotations 134-1, 134-2 each represent a same address, but in different formats, the combined confidence score 140 of “97.44%” is higher than the respective confidence scores 138-1, 138-2.

Furthermore, the combined confidence score 140 is provided with an indication of a number of related annotations 134, in this example “x2”, indicating that the combined confidence score 140 is associated with two annotations 134.

Also depicted at the timeline 146 of FIG. 1C is an indication 152 that the combined confidence score 140 is above or below a given threshold. For example, the computing device 102 and/or the confidence score engine 136 and/or the timeline engine 144 may have access to a given confidence score threshold, for example as depicted, “95%” and the computing device 102 and/or the confidence score engine 136 and/or the timeline engine 144 may determine whether the combined confidence score 140 is above such a confidence score threshold, and generate the indication 152 accordingly. Indeed, as depicted the indication 152 indicates that the combined confidence score 140 is above the given threshold of “95%”. Alternatively, more than one given confidence score threshold may be provided, such as “80%”, and “95” and the indications 152 may be provided in the form of color coding scheme; for example, a combined confidence score 140 that is 80% or lower may be associated with a color “red” indicating a poor combined confidence score, a combined confidence score 140 that is above 95%, may be associated with a color “green” indicating a good combined confidence score, while a combined confidence score 140 that is higher than 80% but 95% or lower may be associated with a color “yellow” indicating a combined confidence score that is between poor and good. However, any suitable indications 152 are within the scope of the present specification.

Also depicted at the timeline 146 of FIG. 1C is a visual linkage 154 between the two or more annotations 134-1, 134-2 that are related. For example, as depicted the visual linkage 154 comprises an arrow between the annotations 134-1, 134-2, however the visual linkage 154 may be provided in any suitable format, which may be based on any suitable combination of arrows, lines, colors, text, graphics, and the like, that indicate that the annotations 134-1, 134-2 are related (and/or any suitable number of annotations 134 that are related). For example, the visual linkage 154 may comprise one or more of: one or more lines between the two or more annotations 134-1, 134-2 that are related; one or more arrows between the two or more annotations 134-1, 134-2 that are related; and one or more of text and graphics at the two or more annotations 134-1, 134-2 that are related.

Attention is next directed to FIG. 2, which depicts a schematic block diagram of an example of the computing device 102. While the computing device 102 is depicted in FIG. 2 as a single component, functionality of the computing device 102 may be distributed among a plurality of components, such as a plurality of servers and/or cloud computing devices.

As depicted, the computing device 102 comprises: a communication unit 202, a processing unit 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. The controller 218 is understood to be communicatively connected to other components of the computing device 102 via the common data and address bus 216. Hereafter, the at least one application 222 will be interchangeably referred to as the application 222.

Furthermore, while the memories 206, 214 are depicted as having a particular structure and/or configuration, (e.g., separate RAM 206 and ROM 214), memory of the computing device 102 may have any suitable structure and/or configuration.

While not depicted, the computing device 102 may include one or more of an input device and/or a display screen, which are also understood to be communicatively coupled to the communication unit. However, as depicted, the controller 218 is depicted as communicatively coupled to the display screen 120 external to the computing device 102.

As shown in FIG. 2, the computing device 102 includes the communication unit 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication unit 202 may include one or more wired and/or wireless input/output (I/O) interfaces 210 that are configurable to communicate with other components of the system 100. For example, the communication unit 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication unit 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the computing device 102 is not a generic controller and/or a generic device, but a device specifically configured to implement functionality for enhanced processing of sensor-based annotations. For example, in some examples, the computing device 102 and/or the controller 218 specifically comprises a computer executable engine configured to implement functionality for enhanced processing of sensor-based annotations.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 102 as described herein are maintained, persistently, at the memory 220 and used by the controller 218, which makes appropriate utilization of volatile storage during the execution of such programming instructions.

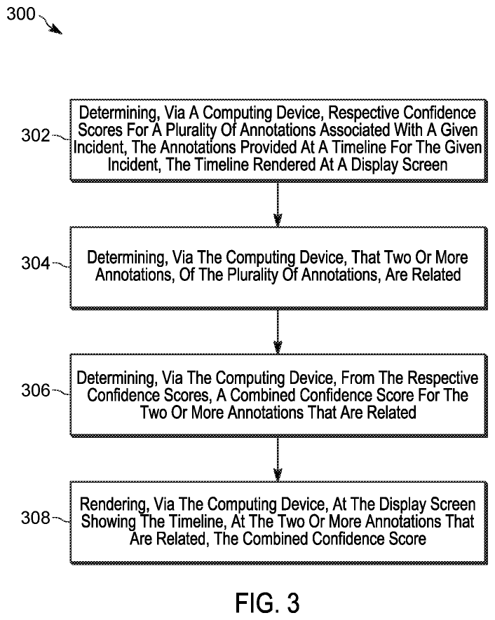

Furthermore, the memory 220 stores instructions corresponding to the at least one application 222 that, when executed by the controller 218, enables the controller 218 to implement functionality for enhanced processing of sensor-based annotations, including but not limited to, the blocks of the method set forth in FIG. 3.

As depicted, the memory 220 further stores an annotation module 224, a confidence score module 226 and a timeline module 228, which may be stored separately from the application 222 and/or may be components of the application 222. The annotation module 224, the confidence score module 226 and the timeline module 228 respectively correspond to machine-readable instructions for respectively implementing the annotation engine 132, the confidence score engine 136 and the timeline engine 144.

Furthermore, while not depicted, the memory 220 may store one or more components of the storage component 114 (e.g., one or more of the sensor data 106, the incident records 126, the annotation 134 and the historical data 142) and/or at least a portion of the storage component 114 may be combined with the memory 220.

In illustrated examples, when the controller 218 executes the one or more applications 222, the controller 218 is enabled to: determine respective confidence scores for a plurality of annotations associated with a given incident, the annotations provided at a timeline for the given incident, the timeline rendered at a display screen; determine that two or more annotations, of the plurality of annotations, are related; determine, from the respective confidence scores, a combined confidence score for the two or more annotations that are related; and render at the display screen showing the timeline, at the two or more annotations that are related, the combined confidence score.

The application 222 and/or the modules 224, 226, 228 may include programmatic algorithms, and the like, to implement functionality as described herein.

Alternatively, and/or in addition to programmatic algorithms, the application 222 and/or the modules 224, 226, 228 may include one or more machine learning algorithms to implement functionality as described herein. The one or more machine learning algorithms of the application 222 and/or the modules 224, 226, 228 may include, but are not limited to one or more of: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

In examples where the application 222 and/or the modules 224, 226, 228 includes one or more machine learning algorithms, the computing device 102 may be operated in a learning mode to “teach” the one or more machine learning algorithms to implement respectively functionality thereof. For example feedback may be provided to the computing device 102 indicating accuracy of a determined annotation 134 and/or accuracy of a determined confidence score 138 and/or accuracy of a determined combined confidence score 140 such that one or more of annotations 134, confidence scores 138 and combined confidence scores 140 that are later determined may be more accurate.

While details of the sensor devices 104 and the PSAP terminal 116 are not depicted, the sensor devices 104 and the PSAP terminal 116 may have components similar to the computing device 102 but adapted, for the respective functionality thereof. For example, a sensor device 104 is understood to include one or more sensors, and the like, for acquiring media, such one or more sensors including, but not limited to, a camera, a video camera, a microphone, and/or any other suitable sensor and/or a combination thereof.

Attention is now directed to FIG. 3, which depicts a flowchart representative of a method 300 for enhanced processing of sensor-based annotations. The operations of the method 300 of FIG. 3 correspond to machine readable instructions that are executed by the computing device 102, and specifically the controller 218 of the computing device 102. In the illustrated example, the instructions represented by the blocks of FIG. 3 are stored at the memory 220 for example, as the application 222 and/or the modules 224, 226, 228. The method 300 of FIG. 3 is one way that the controller 218 and/or the computing device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1A, as well.

At a block 302, the controller 218 and/or the computing device 102 determines respective confidence scores 138 for a plurality of annotations 134 associated with a given incident, the plurality of annotations 134 provided at the timeline 146 for the given incident, the timeline 146 rendered at a display screen 120.

As has been previously described, the plurality of annotations 134 may be associated with the given incident via timestamps and/or other information of the annotations 134 that are determined to be associated with a given incident record 126.

Furthermore, the plurality of annotations 134 associated with the given incident may comprise one or more of:
A real-time annotation 134, such as an annotation 134 generated by the annotation engine 132 using sensor data 106 (e.g., audio data and/or video data) that is being streamed, in real-time, to the computing device 102.
A stored annotation 134, such as an annotation 134 stored at the storage component 114.
A machine-learning-determined annotation 134; for example, when the annotation engine 132 implements one or more machine learning algorithms to generate annotations 134 from the sensor data 106, such an annotation 134 may comprise a machine-learning-determined annotation 134.
A video-analysis determined annotation 134; for example, when the annotation engine 132 implements one or more analysis engines to generate annotations 134 from the sensor data 106, and the sensor data 106, from which such annotations 134 are generated, comprises video data, such an annotation 134 may comprise a video-analysis determined annotation 134; indeed, in these examples, an analysis engine implemented by the annotation engine 132 may comprise a video analysis engine.
An audio-analysis determined annotation 134; for example, when the annotation engine 132 implements one or more analysis engines to generate annotations 134 from the sensor data 106, and the sensor data 106, from which such annotations 134 are generated, comprises audio data, such an annotation 134 may comprise a audio-analysis determined annotation 134; indeed, in these examples, an analysis engine implemented by the annotation engine 132 may comprise an audio analysis engine.
A human-generated annotation 134; for example, when an annotation 134 is generated via the field 128 of the GUI 130, and/or by a similar field of GUI of an incident application being implemented at the communication device of the sensor device 104-1, such an annotation 134 may comprise a human-generated annotation 134.

However, any suitable annotations 134 are within the scope of the present specification.

At a block 304, the controller 218 and/or the computing device 102 determines that two or more annotations 134, of the plurality of annotations 134, are related.

For example, as described previously, two or more annotations 134 may comprise similar and/or same information, such as a similar and/or same address, a similar and/or same license plate number, an indication of a similar and/or same event, such as a gunshot, and/or an indication of a similar and/or same object (e.g., an indication of a similar and/or same object in two more sets of sensor data 106, and the like, including but not limited to, two or more sets of video data, and/or an image and a set of video data), and the like. As such, the controller 218 and/or the computing device 102 may determine that the two or more annotations 134 are related. Furthermore it is understood that the two or more annotations 134 may be further determined to be related to a same given event.

Hence, put another way, determining that two or more of the plurality of annotations 134 are related may comprise determining that the two or more annotations 134 are associated with one or more of same information of the given incident and a same event of the given incident.

At a block 306, the controller 218 and/or the computing device 102 determines, from the respective confidence scores 138, a combined confidence score 140 for the two or more annotations 134 that are related.

For example, the combined confidence score 140 may be further based on one or more of:
A number of the two or more annotations 134 that are related. For example, as a number of the two or more annotations 134 that are related increases, the combined confidence score 140 may increase. Put another way, when three annotations 134 are determined to be related, a combined confidence score 140 for the three annotations 134 may be higher than a combined confidence score 140 for two (e.g., of the three) annotations 134 that are determined to be related. Put yet another way, as a number of annotations 134 that indicate same and/or similar information and/or events increases, a combined confidence score 140 may increase. Hence, for example, with brief reference to FIG. 1C, when a third annotation 134 is added to the timeline 146 that indicates the address “123 Main Street”, and the like, the combined confidence score 140 for the three annotations 134 may be greater than the combined confidence score 140 of “97.44%” for the two annotations 134-1, 134-2. Indeed, such an example further indicates that the combined confidence score 140 may be dynamic and updated as new related annotations 134 are added to the timeline 146; in these examples, the visual linkage 154 may also be updated to show visual linkages between new related annotations 134 and related annotations 134 already at the timeline 146.
Respective quality of one or more of sensor data 106, audio data and video data that generated a respective annotation 134 of the two or more annotations 134 that are related. For example, as has already been explained, some confidence scores 138 may be lower or higher than other confidence scores 138 based on quality of the sensor data 106. Such quality may further be represented in weights of confidence scores 138 that are used to generate the combined confidence score 140. For example relatively lower weight may be given to confidence scores 138 that are based on poorer quality sensor data 106, and relatively higher weight may be given to confidence scores 138 that are based on higher quality sensor data 106. Such weights may be stored in the historical data 142 and/or separate from the historical data 142.
One or more of a type and an accuracy of a sensor device 104 used to capture one or more of the sensor data 106, the audio data and the video data. For example, as has already been explained, some confidence scores 138 may be lower or higher than other confidence scores 138 based on a type and/or an accuracy of a sensor device 104. Such type and/or an accuracy of a sensor device 104 may further be represented in weights of confidence scores 138 that are used to generate the combined confidence score 140, with lower weights given to confidence scores 138 that are based on sensor data 106 from a type of a sensor device 104 having a relatively lower accuracy, and higher weights given to confidence scores 138 that are based on sensor data 106 from a type of a sensor device 104 having a relatively higher accuracy. Such weights may be stored in the historical data 142 and/or separate from the historical data 142.
A respective frequency associated with the two or more annotations 134 that are related. For example, certain types of annotations 134 may be determined more than once, and/or at a given frequency. For example, an annotation 134 that indicates a given license plate detected in video data, may be determined more than one time from the video data, for example, at a given frequency. Such respective frequencies may further be represented in weights of respective confidence scores 138 that are used to generate the combined confidence score 140, with lower weight given to confidence scores 138 associated with annotations 134 relatively lower frequencies (e.g., below a threshold frequency), and higher weight given to confidence scores 138 associated with annotations 134 having relatively higher frequencies (e.g., above a threshold frequency).
A respective age of the two or more annotations 134 that are related. For example, two annotations 134 that are related may be determined over time and/or at different times. Confidence scores 138 associated with older annotations 134 may be given a lower weight as compared to confidence scores 138 associated with newer annotations 134.
A respective type of content associated with the two or more annotations 134 that are related. For example, confidence scores 138 associated with annotations 134 based on video data may be given a relatively higher weight than annotations based on audio data. Such weights may be stored in the historical data 142 and/or separate from the historical data 142.
A comparison of at least one of the two or more annotations 134 that are related with the historical data 142. For example, an annotation 134, and/or information associated therewith, may be compared with the historical data 142 to determine a weight of a respective confidence score 138 of the annotation 134. As has already been described, the historical data 142 may comprise weights indicating accuracy of previous annotations 134 associated with the sensor devices 104 and/or the first responder 108 and/or the user 112 and/or the PSAP terminal 116 and/or the user 118. Hence, when a present annotation 134 is determined to be associated with one or more of a sensor device 104 and/or the first responder 108 and/or the user 112 and/or the PSAP terminal 116 and/or the user 118, and an associated weight of the sensor device 104 and/or the first responder 108 and/or the user 112 and/or the PSAP terminal 116 and/or the user 118 is stored in the historical data 142, a respective confidence score 138 of the present annotation 134 may be weighted using the associated weight.
Respective indications that a machine learning algorithm has verified a human-generated annotation 134 of the two or more annotations 134 that are related, and/or further respective indications that a human has verified a machine-learning-determined annotation 134 of the two or more annotations 134 that are related. For example, the computing device 102 may include a verification engine (not depicted, but which functionality thereof may be incorporated into the annotation engine 132). Such a verification may receive a human-generated annotation 134 that may have been generated via the user 118 listening to audio data of a 911 call and interacting with the field 128, such a verification engine may verify the human-generated annotation 134 by comparing, using a machine learning algorithm, the human-generated annotation 134 with an annotation 134 generated from the same audio data by the annotation engine 132: an indication of the verification may be provided to the confidence score engine 136 for use in assigning weights to associated confidence scores 138. Similarly, the verification engine may receive a machine learning generated annotation 134 from the annotation engine 132, for example based on audio data of a 911 call, and transmit the machine learning generated annotation 134 to the PSAP terminal 116 such that the user 118 who participated in the 911 call, may verify (e.g., via interaction with the PSAP terminal 116) the machine learning generated annotation 134; for example, the machine learning generated annotation 134, such as an address mentioned on the 911 call, may be presented at the display screen 120 and the user 118 may verify that the address is the address mentioned on the 911 call: an indication of the verification may be transmitted to the computing device 102 for use by the confidence score engine 136 in assigning weights to associated confidence scores 138. A confidence score 138 associated with a verified human-generated annotation 134 may be assigned a relatively higher weight than a confidence score 138 associated with a non-verified human-generated annotation 134. Similarly, a confidence score 138 associated with a verified machine-learning generated annotation 134 may be assigned a relatively higher weight than a confidence score 138 associated with a non-verified machine-learning generated annotation 134.
Historical accuracy of one or more of the human and the machine learning algorithm (e.g., that verified, respectively, the machine-learning generated annotation 134 and the human-generated annotation 134). For example, the human and the machine learning algorithm may have their own verifications verified (e.g., by another human and/or another machine learning algorithm), for example after the given incident is resolved, their respective historical accuracies may be stored in the form of weights in the historical data 142, and the like, and used as the weights for associated confidence scores 138.

Any other suitable factors, however, for weighting confidence scores 138, when determining the combined confidence score 140, is within the scope of the present specification.

Indeed, it is hence further understood that the combined confidence score 140 may be further based on a given weighting scheme that combines the respective confidence scores 138 for the two or more annotations 134 that are related.

For example, the controller 218 and/or the computing device 102 may have access to a table, and/or a database (e.g., which may be stored at the storage component 114, and/or which may be a component of the application 222 and/or the confidence score engine 136) such as Table 1 hereafter:

TABLE I

| | Criteria | Criteria |
|---|---|---|
| Annotation Criteria | Score | Weight |
| Human Generated Annotation | 85 | 100 |
| Machine Learning Generated Annotation | 85 | 95 |
| Content Type = Video Data | 100 | 70 |
| Video Quality Above 720p Threshold Resolution | 70 | 80 |
| Video Quality 720p Threshold Resolution Or Lower | 60 | 70 |
| Content Type = Audio Data | 95 | 80 |
| Audio Quality With Background Noise Below 50 dB | 80 | 90 |
| Audio Quality With Background Noise 50 dB Or | 50 | 60 |
| Higher | | |

For example, Table 1 lists, in rows, different criteria for annotations 134 with respective criteria scores and criteria weights. While Table 1 lists certain types of annotation criteria, such a list is not to be considered exhaustive and any suitable type of annotation criteria, and respective criteria scores and criteria weights, is within the scope of the present specification.

A criteria score may comprise a score assigned to a particular type of annotation criteria and a weight assigned to the particular type of annotation criteria. For example, a given annotation 134 may have more than one associated criteria. Furthermore, the criteria scores for a given annotation 134 may represent relative weights of the different criteria relative to one another for a given annotation 134. In contrast, the criteria weights may represent weights of the different criteria for one annotation 134 relative to another annotation 134, which is illustrated in Equation (1) below. In particular, a confidence score for a single annotation 134 may be based on one or more criteria from Table 1; an initial confidence score for an annotation 134 may hence be determined using the criteria score; furthermore, the initial confidence score may be altered by applying a respective criteria weight. In some examples, the criteria scores and/or the criteria weights may be predetermined, for example by an agency and/or an entity maintaining Table 1, and the like.

For example, a first annotation 134 may comprise a machine-learning annotation 134 may be based on sensor data 106 that comprises video data, and which may have a resolution of 1080p (e.g., above a threshold resolution of 720p), and hence is associated with three annotation criteria, three associated criteria weights and three associated criteria weights. A second annotation 134 may comprise given annotation 134 may have more than one associated criteria; for example, a machine-learning annotation 134 may be based on sensor data 106 that comprises audio data, and which may background noise above 50 dB, and hence is also associated with three annotation criteria, three associated criteria weights and three associated criteria weights.

The following Equation (1) may be used to determine a combined confidence score for a an “m” number of related annotations 134, where m is 2 or more:

Combined Confidence=Σₘ₌₁(ConfScₘ)*(Σₙ₌₁(CritScₙ)*(CWₙ)/(n))/m Eq. (1)

In Equation (1), ConfSc comprises a confidence score 138 for an “m^{th}”, annotation 134. Furthermore, a given “m^{th}” annotation 134 may be associated with an “n” number of annotation criteria; as such, CritScₙ comprises a criteria score for an “n^{th}” criteria of an “m^{th}” annotation 134, while CWₙ comprises a criteria weight for the “n^{th}” criteria for the “m^{th}” annotation 134. Put another way, each of an “m” number of annotations 134, there may be a respective “n” number of criteria.

Hence, continuing with the example above, the first and second annotations 134 may be determined to be related (e.g., m=2). When a first annotation 134, of the two annotations 134, comprises a machine-generated annotation 134 based on sensor data 106 that comprises video data, and which may have a resolution of 1080p, there may be three associated criteria (e.g., n=3) from Table 1 of “Machine Learning Generated Annotation”, “Content Type=Video Data” and “Video Quality Above 720p Threshold Resolution” with three associated criteria scores and criteria weights. Similarly, the second annotation 134, of the two annotations 134, comprises a machine-generated annotation 134 based on sensor data 106 that comprises audio data, and which may have a background noise level of greater than 50 dB, there may again be three associated criteria (e.g., n=3) from Table 1 of “Machine Learning Generated Annotation”, “Content Type=Audio Data” and “Audio Quality With Background Noise 50 dB Or Higher” with three associated criteria scores and criteria weights. Equation (1) may hence be used to determine the combined confidence score 140.

However, any suitable scheme for determining a combined confidence score 140 is within the scope of the present specification.

At a block 308, the controller 218 and/or the computing device 102 renders, at the display screen 120 showing the timeline 146, at the two or more annotations 134 that are related, the combined confidence score 140. Examples of such rendering are depicted in FIG. 1C.

However, in some examples, the method 300 may further comprise the controller 218 and/or the computing device 102 rendering, at the display screen 120 showing the timeline 146, the visual linkage 154 between the two or more annotations 134 that are related, as also depicted in FIG. 1C.

In yet further examples, the method 300 may further comprise the controller 218 and/or the computing device 102 rendering, at the display screen 120 showing the timeline 146, a number of the two or more annotations 134 that are related, that were used to determine the combined confidence score 140, as also depicted in FIG. 1C (e.g., in the form of the “x2” indications).

In yet further examples, the method 300 may further comprise the controller 218 and/or the computing device 102 rendering, at the display screen 120 showing the timeline, the indication 152 that the combined confidence score 140 is above or below a given threshold, as also depicted in FIG. 1C.

I The method 300 may comprise any other suitable features. For example, the method 300 may further comprise the controller 218 and/or the computing device 102 providing, at the display screen, an interface for selecting respective related annotations with respective combined confidence scores 140 that meet given thresholds.

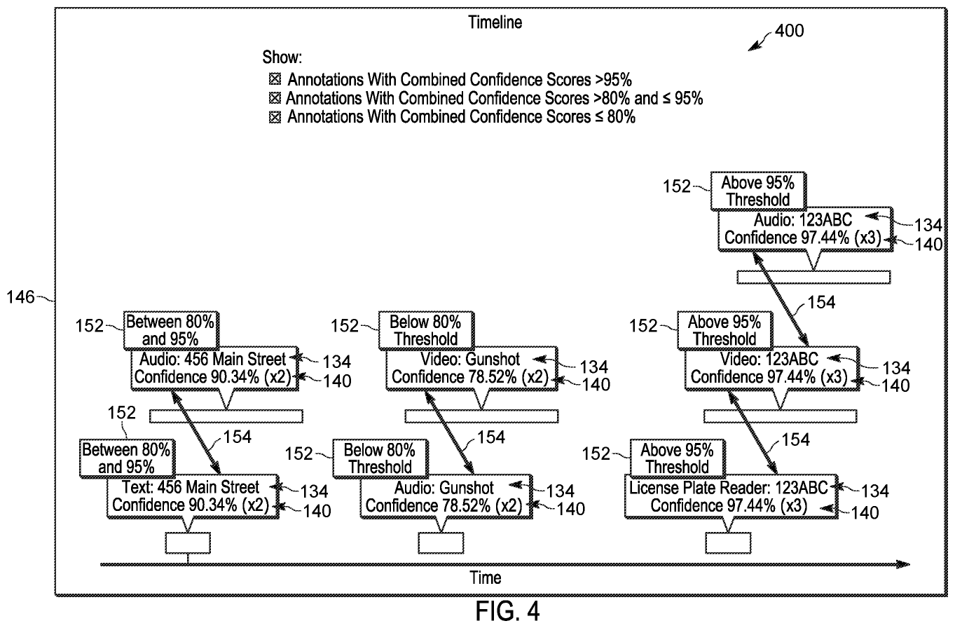

For example, attention is next directed to FIG. 4, which depicts the timeline 146 adapted to include an interface 400 for selecting respective related annotations 134 with respective combined confidence scores 140 that meet given threshold conditions.

For example, as depicted, three sets of related annotations 134 are depicted. A first set of two related annotations 134, at a left side of the timeline 146, has a combined confidence score 140 of “90.34%” and hence is between an 80% combined confidence score threshold and a 95% combined confidence score threshold as indicated by respective indications 152.

A second set of three related annotations 134, at a right side of the timeline 146, has a combined confidence score 140 of “97.44%” and hence is above a 95% combined confidence score threshold as indicated by respective indications 152. Furthermore, a number of the second set of three related annotations 134 is shown by the indication “x3” and the visual linkage 154 for the second set of three related annotations 134 comprises two arrows between the three related annotations 134.

A third set of two related annotations 134, between the first and second sets, has a combined confidence score 140 of “78.42%” and hence is below the 80% combined confidence score threshold as indicated by respective indications 152.

As depicted, the interface 400 comprises selection boxes associated with different combined confidence score threshold conditions. For example, a first selection box is for selecting sets of annotations 134 with combined confidence scores of greater than 95% at the timeline 146, a second selection box is for selecting sets of annotations 134 with combined confidence scores of between 80 and 95% at the timeline 146, and a third selection box is for selecting sets of annotations 134 with combined confidence scores of less than 80% at the timeline 146. As all the selection boxes of the interface 400 in FIG. 4 are selected (e.g., an “X” is in each selection box), all three sets of related annotations 134 are shown. However, as a selection box is unselected (e.g., via the input device 122), sets of related annotations 134 that meet the given thresholds for an unselected selection box may be removed from the timeline 146; conversely, as an unselected selection box is selected, sets of related annotations 134 that meet the given thresholds for an a selected selection box may be added to the timeline 146. As such, the user 118 may select or unselect different sets of related annotations 134 at the timeline 146 that meet different given threshold conditions. Put another way, the computing device 102 and/or the controller 218 may be further configured to change rendering of the annotations 134 at the display screen 120 based on input received via the interface 400.

While the timeline 146 in FIG. 4 shows only three sets of related annotations 134, in other examples, the timeline 146 in FIG. 4 may show more than three sets of related annotations 134 or fewer than three sets of related annotations 134.

Similarly, while the timelines 146 provided herein show annotations 134 associated with one given event, in other examples, the timelines 146 provided herein may show annotations 134 associated with a plurality of given events, with respective related annotations 134 for the plurality of given events provided with respective combined confidence scores 140 accordingly.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, cannot control a display screen and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
determining, via a computing device, respective confidence scores for a plurality of annotations associated with a given incident, the plurality of annotations provided at a timeline for the given incident, the timeline rendered at a display screen;
determining, via the computing device, that two or more annotations, of the plurality of annotations, are related;
determining, via the computing device, from the respective confidence scores, a combined confidence score for the two or more annotations that are related; and
rendering, via the computing device, at the display screen showing the timeline, at the two or more annotations that are related, the combined confidence score.

2. The method of claim 1, wherein the plurality of annotations associated with the given incident comprise one or more of:
a real-time annotation;
a stored annotation;
a machine-learning-determined annotation;
a video-analysis determined annotation;
an audio-analysis determined annotation; and
a human-generated annotation.

3. The method of claim 1, wherein the combined confidence score is further based on one or more of:
a number of the two or more annotations that are related;
respective quality of one or more of sensor data, audio data and video data that generated a respective annotation of the two or more annotations that are related;
one or more of a type and an accuracy of a sensor device used to capture one or more of the sensor data, the audio data and the video data;
a respective frequency associated with the two or more annotations that are related;
a respective age of the two or more annotations that are related;
a respective type of content associated with the two or more annotations that are related;
a comparison of at least one of the two or more annotations that are related with historical data;
respective indications that a machine learning algorithm has verified a human-generated annotation f the two or more annotations that are related;
further respective indications that a human has verified a machine-learning-determined annotation of the two or more annotations that are related; and
historical accuracy of one or more of the human and the machine learning algorithm.

4. The method of claim 1, wherein the combined confidence score is further based on a given weighting scheme that combines the respective confidence scores for the two or more annotations that are related.

5. The method of claim 1, wherein determining that two or more of the plurality of annotations are related comprises:
determining that the two or more annotations are associated with one or more of same information of the given incident and a same event of the given incident.

6. The method of claim 1, further comprising:
rendering, at the display screen showing the timeline, a visual linkage between the two or more annotations that are related.

7. The method of claim 6, wherein the visual linkage comprises one more of:
one or more lines between the two or more annotations that are related;
one or more arrows between the two or more annotations that are related; and
one or more of text and graphics at the two or more annotations that are related.

8. The method of claim 1, further comprising:
rendering, at the display screen showing the timeline, a number of the two or more annotations that are related, that were used to determine the combined confidence score.

9. The method of claim 1, further comprising:
rendering, at the display screen showing the timeline, an indication that the combined confidence score is above or below a given threshold.

10. The method of claim 1, further comprising:
providing, at the display screen, an interface for selecting respective related annotations with respective combined confidence scores that meet given threshold conditions.

11. A device comprising:
a controller configured to:
determine respective confidence scores for a plurality of annotations associated with a given incident, the plurality of annotations provided at a timeline for the given incident, the timeline rendered at a display screen;
determine that two or more annotations, of the plurality of annotations, are related;
determine, from the respective confidence scores, a combined confidence score for the two or more annotations that are related; and
render, at the display screen showing the timeline, at the two or more annotations that are related, the combined confidence score.

12. The device of claim 11, wherein the plurality of annotations associated with the given incident comprise one or more of:
a real-time annotation;
a stored annotation;
a machine-learning-determined annotation;
a video-analysis determined annotation;
an audio-analysis determined annotation; and
a human-generated annotation.

13. The device of claim 11, wherein the combined confidence score is further based on one or more of:
a number of the two or more annotations that are related;
respective quality of one or more of sensor data, audio data and video data that generated a respective annotation of the two or more annotations that are related;
one or more of a type and an accuracy of a sensor device used to capture one or more of the sensor data, the audio data and the video data;
a respective frequency associated with the two or more annotations that are related;
a respective age of the two or more annotations that are related;
a respective type of content associated with the two or more annotations that are related;
a comparison of at least one of the two or more annotations that are related with historical data;
respective indications that a machine learning algorithm has verified a human-generated annotation f the two or more annotations that are related;
further respective indications that a human has verified a machine-learning-determined annotation of the two or more annotations that are related; and
historical accuracy of one or more of the human and the machine learning algorithm.

14. The device of claim 11, wherein the combined confidence score is further based on a given weighting scheme that combines the respective confidence scores for the two or more annotations that are related.

15. The device of claim 11, wherein the controller is further configured to determine that two or more of the plurality of annotations are related by:
determining that the two or more annotations are associated with one or more of same information of the given incident and a same event of the given incident.

16. The device of claim 11, wherein the controller is further configured to:
render, at the display screen showing the timeline, a visual linkage between the two or more annotations that are related.

17. The device of claim 16, wherein the visual linkage comprises one more of:
one or more lines between the two or more annotations that are related;
one or more arrows between the two or more annotations that are related; and
one or more of text and graphics at the two or more annotations that are related.

18. The device of claim 11, wherein the controller is further configured to:
render, at the display screen showing the timeline, a number of the two or more annotations that are related, that were used to determine the combined confidence score.

19. The device of claim 11, wherein the controller is further configured to:
render, at the display screen showing the timeline, an indication that the combined confidence score is above or below a given threshold.

20. The device of claim 11, wherein the controller is further configured to:
provide, at the display screen, an interface for selecting respective related annotations with respective combined confidence scores that meet given threshold conditions.
